(19) United States
(12) Patent Application Publication
(10) Pub. No.: US 2015/0084952 A1
(43) Pub. Date: Mar. 26, 2015

(54) SYSTEM, METHOD, AND COMPUTER PROGRAM PRODUCT FOR RENDERING A SCREEN-ALIGNED RECTANGLE PRIMITIVE

(71) Applicant: NVIDIA Corporation, Santa Clara, CA (US)

(72) Inventor: Henry Packard Moreton, Woodside, CA (US)

(73) Assignee: NVIDIA Corporation, Santa Clara, CA (US)

(21) Appl. No.: 14/034,416

(22) Filed: Sep. 23, 2013

(51) Int. Cl. G06T 15/80; G06T 19/20

(52) U.S. Cl. CPC G06T 15/80; G06T 19/20; G06T 2200/04; G06T 2219/008
USPC 345/420

(57) ABSTRACT

A system, method, and computer program product are provided for processing a screen-aligned rectangle within a processing pipeline. The method includes the steps of determining coordinates for a screen-aligned rectangle by projecting a specification line onto a screen-space plane, computing a plane equation associated with the specification line, and rasterizing the screen-aligned rectangle that is within the screen-space plane based on the coordinates and the plane equation. The specification line is within a three-dimensional (3D) space. The plane equation is associated with a rendering parameter for the screen-aligned rectangle. The plane equation may be evaluated by a pixel shader in conjunction with processing the screen-aligned rectangle.

### FIELD OF THE INVENTION

The present invention relates to computer graphics, and more specifically to a screen-aligned rectangle primitive.

### BACKGROUND

A graphics primitive may specify geometric and shading information for an associated graphics object. Three-dimensional (3D) graphics primitives conventionally specify geometric and shading information for triangles, lines, and points in a 3D space. A computer graphics system may represent a 3D graphics scene as a set of 3D graphics primitives, which may be processed by a rendering engine to generate a digital image that depicts the 3D graphics scene. Modern computer graphics systems include a graphics processing unit (GPU) and related software configured to process 3D graphics primitives to generate a corresponding digital image. GPU implementations include application programming interfaces (APIs) and processing pipelines optimized for rendering 3D graphics primitives.

One graphics primitive commonly used in two-dimensional (2D) graphics is a screen-aligned rectangle, typically specified according to 2D screen-space coordinates. One challenge associated with processing a screen-aligned rectangle by a GPU is integrating the screen-aligned rectangle primitive within a 3D rendering model that is processed by the GPU.

Thus, there is a need for addressing this issue and/or other issues associated with the prior art.

### SUMMARY

A system, method, and computer program product are provided for processing a screen-aligned rectangle within a processing pipeline. The method includes the steps of determining coordinates for a screen-aligned rectangle by projecting a specification line onto a screen-space plane, computing a plane equation associated with the specification line, and rasterizing the screen-aligned rectangle that is within the screen-space plane based on the coordinates and the plane equation. The specification line is within a three-dimensional (3D) space. The plane equation is associated with a rendering parameter for the screen-aligned rectangle. The plane equation may be evaluated by a pixel shader in conjunction with processing the screen-aligned rectangle. In one embodiment, each end point of the specification line may include one or more parameters, such as depth (Z), color, a texture space coordinate, or any other attribute or rendering parameter associated with a graphics primitive.

### BRIEF DESCRIPTION OF THE DRAWINGS

FIG. 1A illustrates a flow chart of a method for processing a screen-aligned rectangle, in accordance with one embodiment;

FIG. 1B illustrates a flow chart of a method for computing a plane equation associated with a specification line of FIG. 1A, in accordance with one embodiment;

FIG. 2 illustrates a parallel processing unit (PPU), according to one embodiment;

FIG. 3 illustrates the streaming multi-processor of FIG. 2, according to one embodiment;

FIG. 4 is a conceptual diagram of a graphics processing pipeline implemented by the PPU of FIG. 2, in accordance with one embodiment;

FIG. 5A illustrates a specification line that defines a screen-aligned rectangle, in accordance with one embodiment;

FIG. 5B illustrates a constant Z plane defined by one end point of the specification line of FIG. 5A, in accordance with one embodiment;

FIG. 5C illustrates a perpendicular plane that is perpendicular with respect to the specification line of FIG. 5A, in accordance with one embodiment;

FIG. 5D illustrates an intersection line defined by the constant Z plane of FIG. 5B and the perpendicular plane of FIG. 5C, in accordance with one embodiment;

FIG. 5E illustrates a spanning plane defined by a plane equation based on the specification line of FIG. 5A and the intersection line of FIG. 5E, in accordance with one embodiment;

FIG. 6 illustrates a flow chart of a method for rasterizing a screen-aligned rectangle based on rendering parameters specified by a plane equation, in accordance with one embodiment; and

FIG. 7 illustrates an exemplary system in which the various architecture and/or functionality of the various previous embodiments may be implemented.

### DETAILED DESCRIPTION

A technique is provided for processing a screen-aligned rectangle, which may be specified using a specification line in 3D space having two end points that correspond to two corners of the screen-aligned rectangle. The two end points of the specification line are projected into screen-space to define corresponding corners of the screen-aligned rectangle. In one embodiment, processing the screen-aligned rectangle includes rendering the screen-aligned rectangle, whereby rasterization coverage of the screen-aligned rectangle is determined by the two corresponding corners.

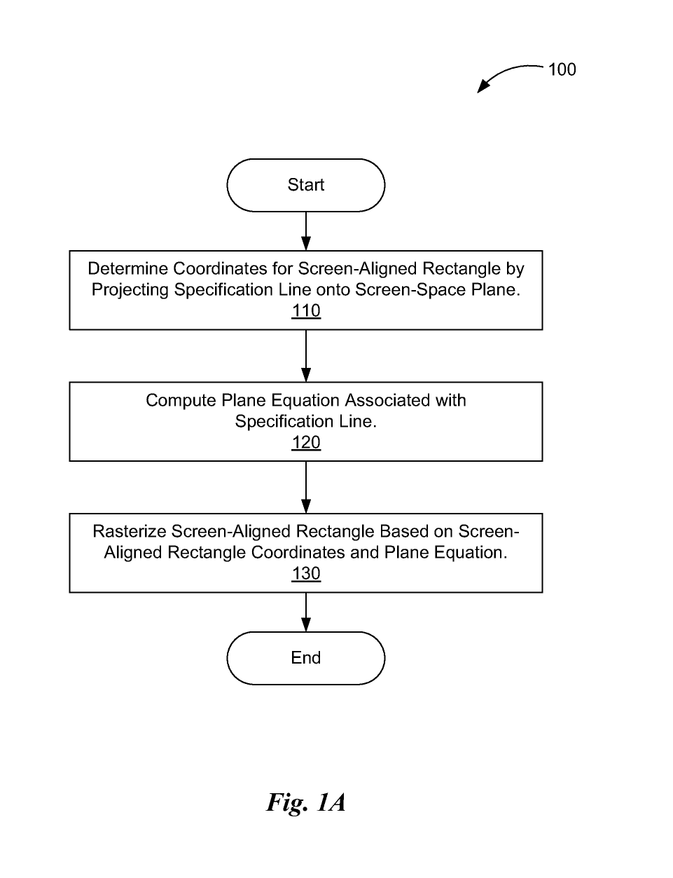

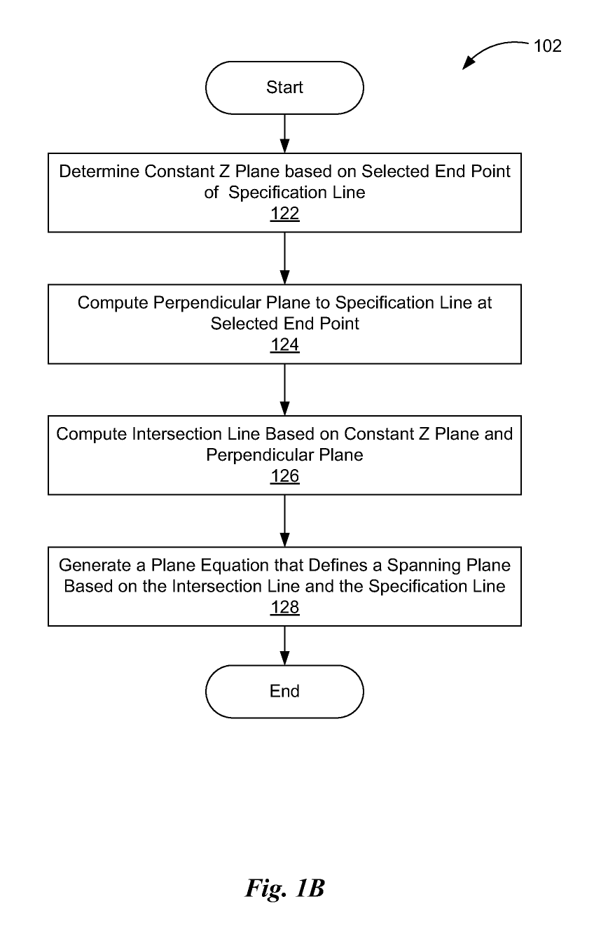

Each end point of the specification line may include one or more parameters, such as depth (Z), color, a texture space coordinate, or any other attribute or rendering parameter associated with a graphics primitive. In FIGS. 1A, 1B, 5A-6 below, the depth parameter Z serves as an exemplar, however, any technically feasible type of rendering parameter may be associated with the end points. In one embodiment, each end point includes two or more different types of rendering parameter, each associated with a corresponding plane equation, computed as described below. Each different type of rendering parameter may serve to define an independent specification line and a corresponding plane equation independent of other plane equations, having only a common projection in screen-space that is the screen-aligned rectangle. For example, a specification line may include end points that define screen-space pixel coverage of the screen-aligned rectangle. The end points may also specify a plane equation for Z values for the screen-aligned rectangle. The end points may further specify two additional plane equations, each corresponding to a different texture space coordinate. The three plane equations may be evaluated at each covered sample of a screen-aligned rectangle in screen-space to yield a Z value for the sample, as well as each of two texture coordinates for performing a two-dimensional texture lookup for the sample. Persons skilled in the art will understand that any parameter associated with rendering a screen-aligned rectangle may be specified and computed for rendering using the teachings disclosed herein without departing the scope and spirit of the present invention.

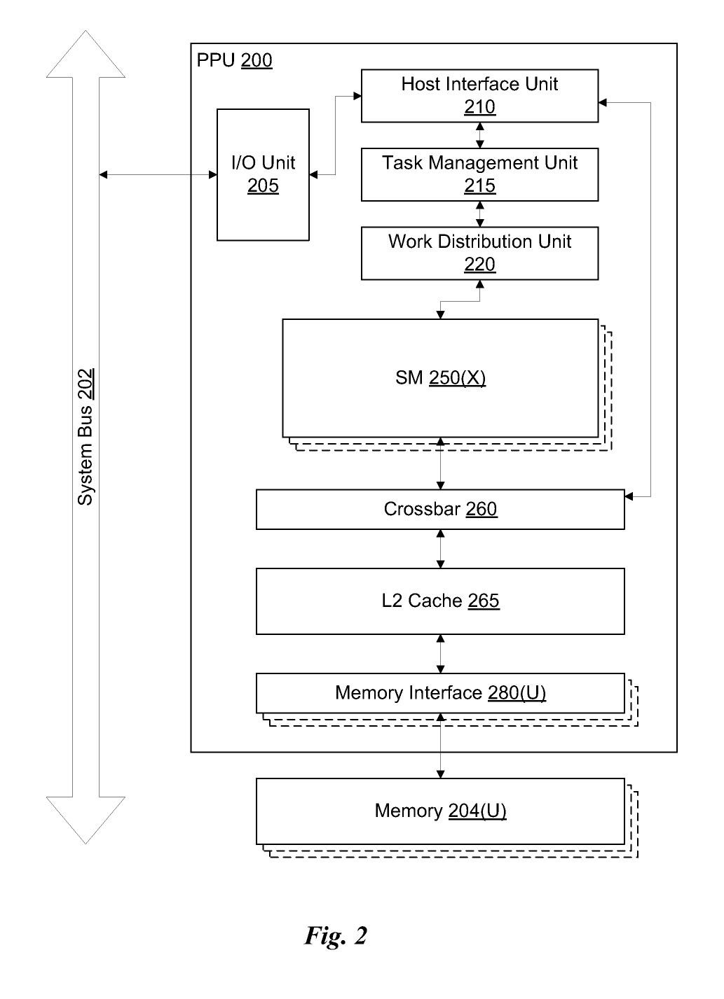

FIG. 1A illustrates a flow chart of a method 100 for processing a screen-aligned rectangle, in accordance with one embodiment. Although method 100 is described in conjunction with FIGS. 2-4, persons of ordinary skill in the art will understand that any system that performs method 100 is within the scope and spirit of embodiments of the present invention. In one embodiment, method 100 is performed by a graphics processing unit (GPU).

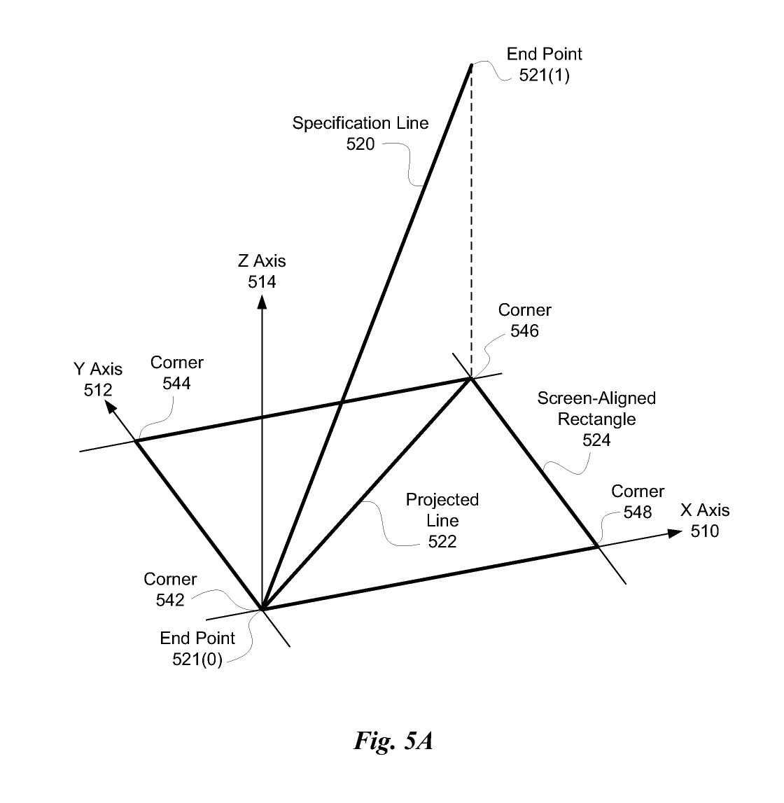

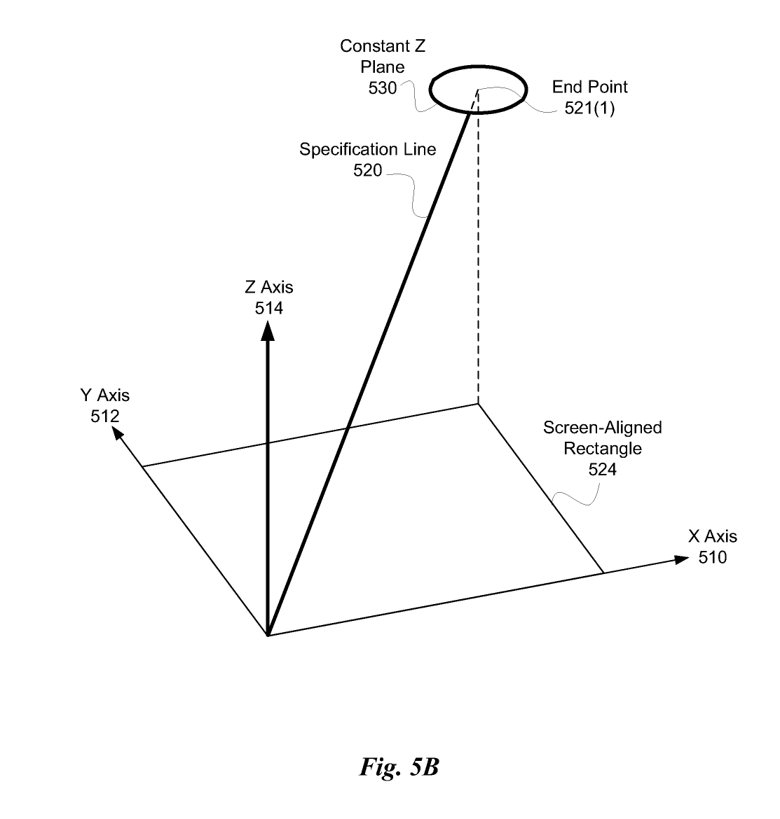

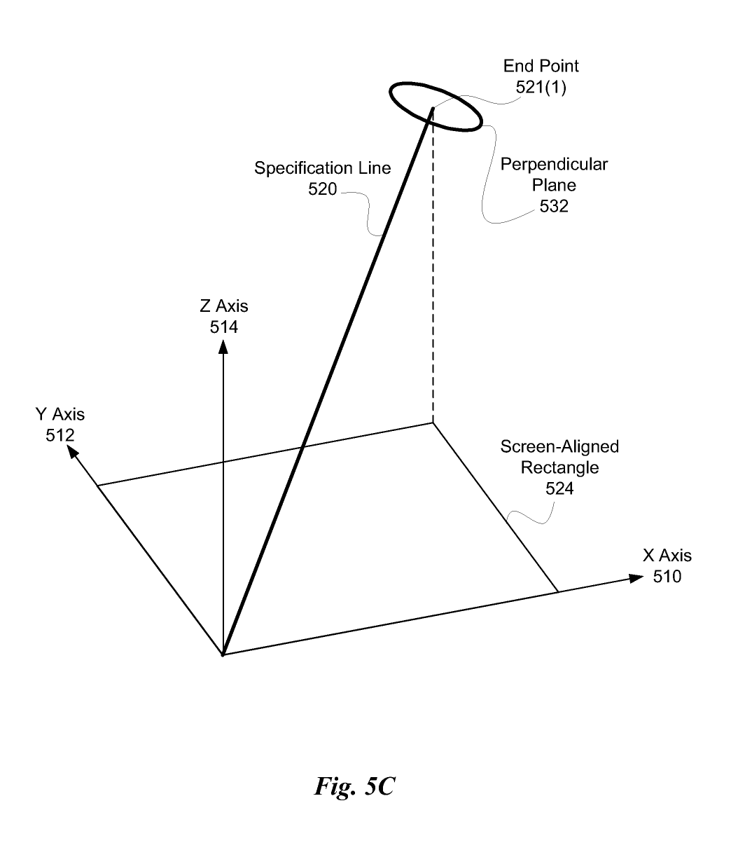

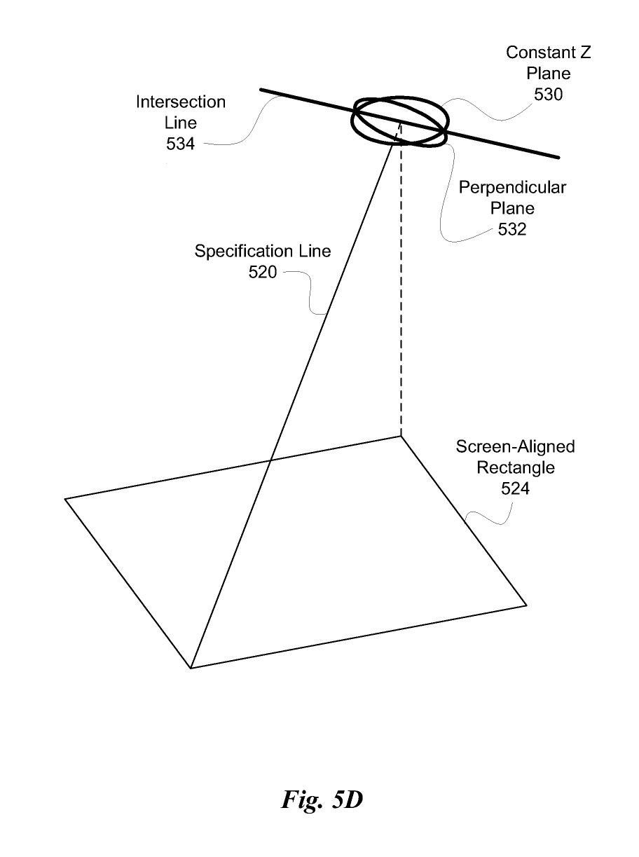

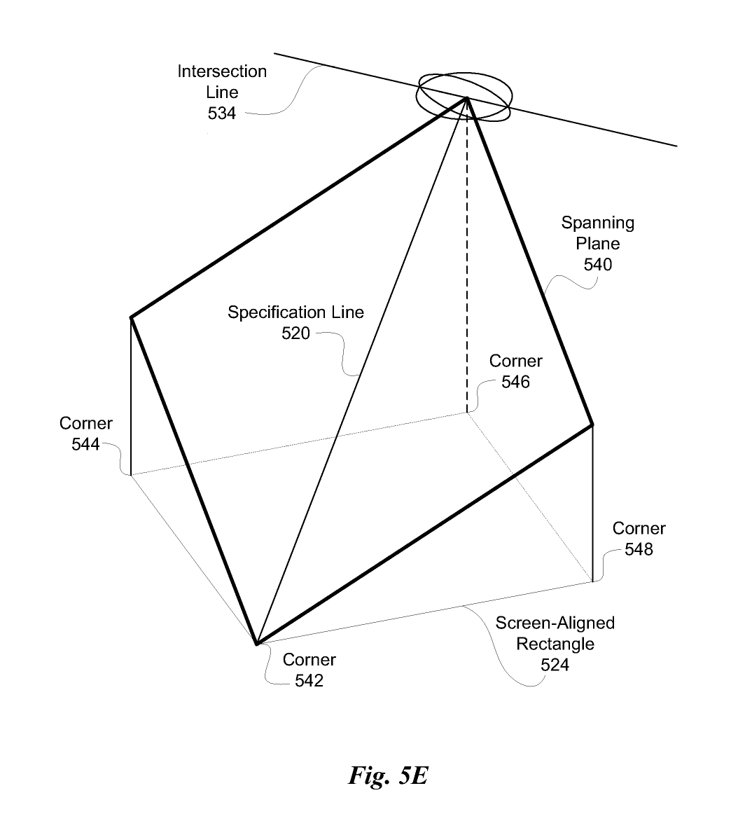

Method 100 begins in step 110, where the GPU determines coordinates for a screen-aligned rectangle by projecting a specification line comprising two end points onto a screen-space plane, where the specification line is within a three-dimensional (3D) space that includes at least X and Y coordinate axes. In one embodiment, the screen-space plane comprises an XY plane within the 3D space. In certain embodiments, as illustrated below in FIGS. 5A-5E, the 3D space further includes a Z axis.

In step 120, the GPU computes a plane equation associated with the specification line. In certain embodiments, N types of parameters (e.g., Z, texture coordinates) are associated with each end point, and a different plane equation is computed for each of the N different types of parameters. In the context of the following description, a plane equation may be represented in the form aX+bY+c, where constants a, b, and c are computed coefficients that are specific to a rendering parameter and the plane equation is evaluated at particular (X,Y) coordinates to compute the rendering parameter at the (X,Y) position in screen-space.

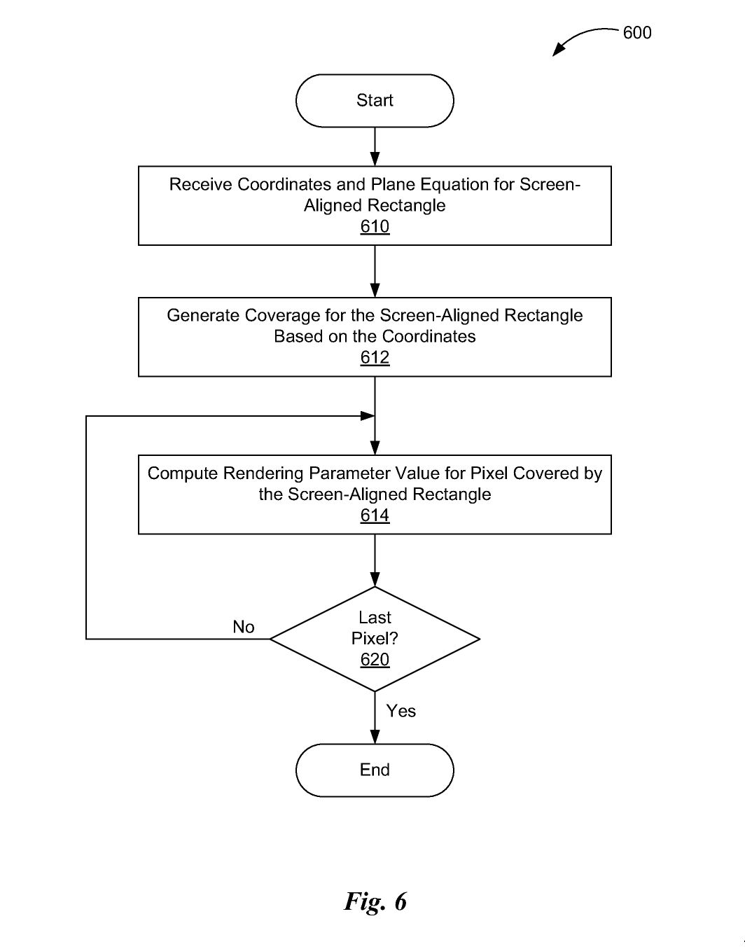

In one embodiment, a method 102, described below in FIG. 1B, implements step 120. In one embodiment, the plane equation is stored into a memory subsystem for later retrieval. In step 130, the GPU rasterizes the screen-aligned rectangle based on the coordinates for the screen-aligned rectangle and at least one associated plane equation. Data associated with the rasterized screen-aligned rectangle may be stored in memory, such as in a graphics surface data structure or frame buffer, for later retrieval. In one embodiment, a method 600, described below in FIG. 6, implements step 130.

FIG. 1B illustrates a flow chart of method 102 for computing a plane equation associated with the specification line of FIG. 1A, in accordance with one embodiment. Although method 102 is described in conjunction with FIGS. 2-4, persons of ordinary skill in the art will understand that any system that performs method 102 is within the scope and spirit of embodiments of the present invention.

Method 102 begins in step 122, where the GPU determines a constant Z plane based on a selected end point of a specification line that specifies the screen-aligned rectangle. Any technically feasible technique may be implemented to select an end point. For example, if an ordered pair of end points comprises the specification line, then the first end point in the ordered pair may define the selected end point. This step is illustrated below in FIG. 5B. In step 124, the GPU computes a perpendicular plane that intersects the selected end point and is perpendicular to the specification line. This step is illustrated below in FIG. 5C. In step 126, the GPU computes an intersection line based on the constant Z plane and the perpendicular plane. This step is illustrated below in FIG. 5D. Any technically feasible techniques may be implemented to determine the constant Z plane, to compute the perpendicular plane, and to compute the intersection line. In step 128, the GPU generates a plane equation based on the intersection line and the specification line. The plane equation defines a spanning plane. This step is illustrated below in FIG. 5E.

Computing the Z value (or any other parameter specified by the spanning plane) for a screen-space sample involves solving the plane equation for the spanning plane at a screen-space coordinate corresponding to the screen-space sample. Therefore, the specification line concisely defines both screen-space coordinates for the screen-aligned rectangle and a plane equation for one or more rendering parameters, such as Z, associated with the screen-aligned rectangle.

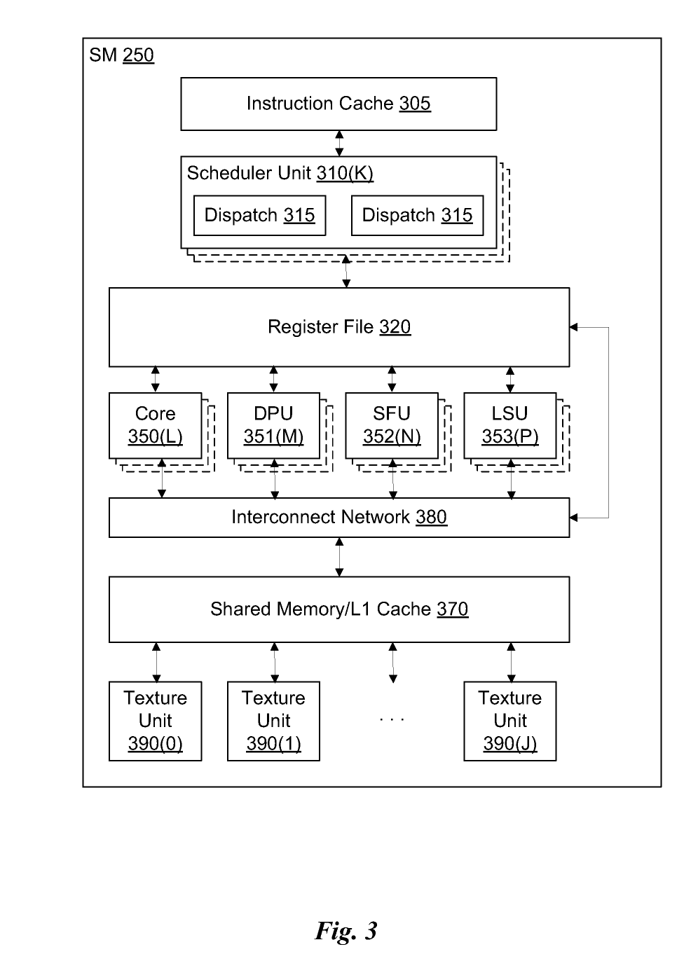

FIG. 2 illustrates a parallel processing unit (PPU) 200, according to one embodiment. While a parallel processor is provided herein as an example of the PPU 200, it should be strongly noted that such processor is set forth for illustrative purposes only, and any processor may be employed to supplement and/or substitute for the same. In one embodiment, the PPU 200 is configured to execute a plurality of threads concurrently in two or more streaming multi-processors (SMs) 250. A thread (i.e., a thread of execution) is an instantiation of a set of instructions executing within a particular SM 250. Each SM 250, described below in more detail in conjunction with FIG. 3, may include, but is not limited to, one or more processing cores, one or more load/store units (LSUs), a level-one (L1) cache, shared memory, and the like.

In one embodiment, the PPU 200 includes an input/output (I/O) unit 205 configured to transmit and receive communications (i.e., commands, data, etc.) from a central processing unit (CPU) (not shown) over the system bus 202. The I/O unit 205 may implement a Peripheral Component Interconnect Express (PCIe) interface for communications over a PCIe bus. In alternative embodiments, the I/O unit 205 may implement other types of well-known bus interfaces.

The PPU 200 also includes a host interface unit 210 that decodes the commands and transmits the commands to a task management unit 215 or other units of the PPU 200 (e.g., memory interface 280) as the commands may specify. The host interface unit 210 is configured to route communications between and among the various logical units of the PPU 200.

In one embodiment, a program encoded as a command stream is written to a buffer by the CPU. The buffer is a region in memory, e.g., memory 204 or system memory, that is accessible (i.e., read/write) by both the CPU and the PPU 200. The CPU writes the command stream to the buffer and then transmits a pointer to the start of the command stream to the PPU 200. The host interface unit 210 provides the task management unit (TMU) 215 with pointers to one or more streams. The TMU 215 selects one or more streams and is configured to organize the selected streams as a pool of pending grids. The pool of pending grids may include new grids that have not yet been selected for execution and grids that have been partially executed and have been suspended.

A work distribution unit 220 that is coupled between the TMU 215 and the SMs 250 manages a pool of active grids, selecting and dispatching active grids for execution by the SMs 250. Pending grids are transferred to the active grid pool by the TMU 215 when a pending grid is eligible to execute, i.e., has no unresolved data dependencies. An active grid is transferred to the pending pool when execution of the active grid is blocked by a dependency. When execution of a grid is completed, the grid is removed from the active grid pool by the work distribution unit 220. In addition to receiving grids from the host interface unit 210 and the work distribution unit 220, the TMU 215 also receives grids that are dynamically generated by the SMs 250 during execution of a grid. These dynamically generated grids join the other pending grids in the pending grid pool.

In one embodiment, the CPU executes a driver kernel that implements an application programming interface (API) that enables one or more applications executing on the CPU to schedule operations for execution on the PPU 200. An application may include instructions (i.e., API calls) that cause the driver kernel to generate one or more grids for execution. In one embodiment, the PPU 200 implements a SIMD (Single-Instruction, Multiple-Data) architecture where each thread block (i.e., warp) in a grid is concurrently executed on a different data set by different threads in the thread block. The driver kernel defines thread blocks that are comprised of k related threads, such that threads in the same thread block may exchange data through shared memory. In one embodiment, a thread block comprises 32 related threads and a grid is an array of one or more thread blocks that execute the same stream and the different thread blocks may exchange data through global memory.

In one embodiment, the PPU 200 comprises X SMs 250(X). For example, the PPU 200 may include 15 distinct SMs 250. Each SM 250 is multi-threaded and configured to execute a plurality of threads (e.g., 32 threads) from a particular thread block concurrently. Each of the SMs 250 is connected to a level-two (L2) cache 265 via a crossbar 260 (or other type of interconnect network). The L2 cache 265 is connected to one or more memory interfaces 280. Memory interfaces 280 implement 16, 32, 64, 128-bit data buses, or the like, for high-speed data transfer. In one embodiment, the PPU 200 comprises U memory interfaces 280(U), where each memory interface 280(U) is connected to a corresponding memory device 204(U). For example, PPU 200 may be connected to up to six memory devices 204, such as graphics double-data-rate, version 5, synchronous dynamic random access memory (GDDR5 SDRAM).

In one embodiment, the PPU 200 implements a multi-level memory hierarchy. The memory devices 204 may be located off-chip in SDRAM coupled to the PPU 200. Data from the memory devices 204 may be fetched and stored in the L2 cache 265, which is located on-chip and is shared between the various SMs 250. In one embodiment, each of the SMs 250 also implements an L1 cache. The L1 cache may be implemented as private memory that is dedicated to a particular SM 250. Each of the L1 caches is coupled to the shared L2 cache 265. Data from the L2 cache 265 may be fetched and stored in each of the L1 caches for processing in the functional units of the SMs 250.

In one embodiment, the PPU 200 comprises a graphics processing unit (GPU). The PPU 200 is configured to receive commands that specify shader programs for processing graphics data. Graphics data may be defined as a set of primitives such as points, lines, triangles, quads (rectangles), triangle strips, and the like. Typically, a primitive includes data that specifies a number of vertices for the primitive (e.g., in a model-space coordinate system) as well as attributes or rendering parameters associated with each vertex of the primitive. Rendering parameters may include one of more of position, color, surface normal vector, texture coordinates, etc. The PPU 200 can be configured to process the graphics primitives to generate a frame buffer (i.e., pixel data for each of the pixels of the display). The driver kernel implements a graphics processing pipeline, such as the graphics processing pipeline defined by the OpenGL API.

An application writes model data for a scene (i.e., a collection of vertices and rendering parameters) to memory, such as system memory associated with the CPU or memory devices 204. The model data defines each of the objects that may be visible on a display. The application then makes an API call to the driver kernel that requests the model data to be rendered and displayed. The driver kernel reads the model data and writes commands to a buffer to perform one or more operations to process the model data. The commands may encode different shader programs including one or more of a vertex shader, hull shader, geometry shader, pixel shader, etc. For example, the TMU 215 may configure one or more SMs 250 to execute a vertex shader program that processes a number of vertices defined by the model data. In one embodiment, the TMU 215 may configure different SMs 250 to execute different shader programs concurrently. For example, a first subset of SMs 250 may be configured to execute a vertex shader program while a second subset of SMs 250 may be configured to execute a pixel shader program. The first subset of SMs 250 processes vertex data to produce processed vertex data and writes the processed vertex data to the L2 cache 265 and/or the memory 204. After the processed vertex data is rasterized (i.e., transformed from three-dimensional data into two-dimensional data in screen-space) to produce fragment data, the second subset of SMs 250 executes a pixel shader to produce processed fragment data, which is then blended with other processed fragment data and written to the frame buffer in memory 204. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The PPU 200 may be included in a desktop computer, a laptop computer, a tablet computer, a smart-phone (e.g., a wireless, hand-held device), personal digital assistant (PDA), a digital camera, a hand-held electronic device, and the like. In one embodiment, the PPU 200 is embodied on a single semiconductor substrate. In another embodiment, the PPU 200 is included in a system-on-a-chip (SoC) along with one or more other logic units such as a reduced instruction set computer (RISC) CPU, a memory management unit (MMU), a digital-to-analog converter (DAC), and the like.

In one embodiment, the PPU 200 may be included on a graphics card that includes one or more memory devices 204 such as GDDR5 SDRAM. The graphics card may be configured to interface with a PCIe slot on a motherboard of a desktop computer that includes, e.g., a northbridge chipset and a southbridge chipset. In yet another embodiment, the PPU 200 may be an integrated graphics processing unit (iGPU) included in the chipset (i.e., Northbridge) of the motherboard.

FIG. 3 illustrates the streaming multi-processor 250 of FIG. 2, according to one embodiment. As shown in FIG. 3, the SM 250 includes an instruction cache 305, one or more scheduler units 310, a register file 320, one or more processing cores 350, one or more double precision units (DPUs) 351, one or more special function units (SFUs) 352, one or more load/store units (LSUs) 353, an interconnect network 380, a shared memory/L1 cache 370, and one or more texture units 390.

As described above, the work distribution unit 220 dispatches active grids for execution on one or more SMs 250 of the PPU 200. The scheduler unit 310 receives the grids from the work distribution unit 220 and manages instruction scheduling for one or more thread blocks of each active grid. The scheduler unit 310 schedules threads for execution in groups of parallel threads, where each group is called a warp. In one embodiment, each warp includes 32 threads. The scheduler unit 310 may manage a plurality of different thread blocks, allocating the thread blocks to warps for execution and then scheduling instructions from the plurality of different warps on the various functional units (i.e., cores 350, DPUs 351, SFUs 352, and LSUs 353) during each clock cycle.

In one embodiment, each scheduler unit 310 includes one or more instruction dispatch units 315. Each dispatch unit 315 is configured to transmit instructions to one or more of the functional units. In the embodiment shown in FIG. 3, the scheduler unit 310 includes two dispatch units 315 that enable two different instructions from the same warp to be dispatched during each clock cycle. In alternative embodiments, each scheduler unit 310 may include a single dispatch unit 315 or additional dispatch units 315.

Each SM 250 includes a register file 320 that provides a set of registers for the functional units of the SM 250. In one embodiment, the register file 320 is divided between each of the functional units such that each functional unit is allocated a dedicated portion of the register file 320. In another embodiment, the register file 320 is divided between the different warps being executed by the SM 250. The register file 320 provides temporary storage for operands connected to the data paths of the functional units.

Each SM 250 comprises L processing cores 350. In one embodiment, the SM 250 includes a large number (e.g., 192, etc.) of distinct processing cores 350. Each core 350 implements a fully-pipelined, single-precision processing unit that includes a floating point arithmetic logic unit and an integer arithmetic logic unit. In one embodiment, the floating point arithmetic logic units implement the IEEE 754-2008 standard for floating point arithmetic. Each SM 250 also comprises M DPUs 351 that implement double-precision floating point arithmetic, N SFUs 352 that perform special functions (e.g., copy rectangle, pixel blending operations, and the like), and P LSUs 353 that implement load and store operations between the shared memory/L1 cache 370 and the register file 320. In one embodiment, the SM 250 includes 64 DPUs 351, 32 SFUs 352, and 32 LSUs 353.

Each SM 250 includes interconnect network 380, configured to connect each of the functional units to the register file 320 and the shared memory/L1 cache 370. In one embodiment, the interconnect network 380 is a crossbar that can be configured to connect any of the functional units to any of the registers in the register file 320 or the memory locations in shared memory/L1 cache 370.

In one embodiment, the SM 250 is implemented within a GPU. In such an embodiment, the SM 250 comprises J texture units 390. The texture units 390 are configured to load texture maps (i.e., a 2D array of texels) from the memory 204 and sample the texture maps to produce sampled texture values for use in shader programs. The texture units 390 implement texture operations such as anti-aliasing operations using mip-maps (i.e., texture maps of varying levels of detail). In one embodiment, the SM 250 includes 16 texture units 390.

The PPU 200 described above may be configured to perform highly parallel computations much faster than conventional CPUs. Parallel computing has advantages in graphics processing, data compression, biometrics, stream processing algorithms, and the like.

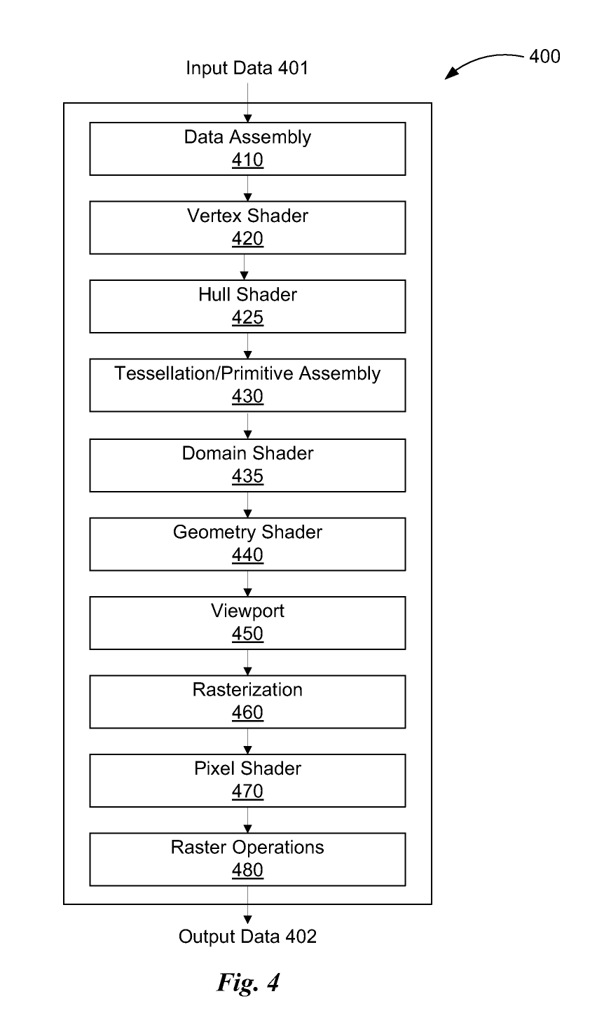

FIG. 4 is a conceptual diagram of a graphics processing pipeline 400 implemented by the PPU 200 of FIG. 2, in accordance with one embodiment. The graphics processing pipeline 400 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 400 receives input data 401 that is transmitted from one stage to the next stage of the graphics processing pipeline 400 to generate output data 402. In one embodiment, the graphics processing pipeline 400 may represent a graphics processing pipeline defined by the OpenGL® API or by DirectX 11® by MICROSOFT.

As shown in FIG. 4, the graphics processing pipeline 400 comprises a pipeline architecture that includes a number of stages. The stages include, but are not limited to, a data assembly stage 410, a vertex shader stage 420, a hull shader stage 425, a tessellation/primitive assembly stage 430, a domain shader stage 435, a geometry shader stage 440, a viewport transform stage 450, a rasterization stage 460, a pixel shader stage 470, and a raster operations stage 480. In one embodiment, the input data 401 comprises commands that configure the processing units to implement the stages of the graphics processing pipeline 400 and high-order geometric primitives to be processed by the stages. The output data 402 may comprise pixel data (i.e., color data) that is copied into a frame buffer or other type of surface data structure in a memory (e.g., memory 204). The SMs 250 may be configured by shader program instructions to function as one or more of the shader stages (e.g., vertex, hull, domain, geometry, and pixel shaders).

The data assembly stage 410 receives the input data 401 that specifies vertex data for high-order graphics geometry. The data assembly stage 410 collects the vertex data defining the high-order graphics geometry in a temporary storage or queue, such as by receiving a command from the host processor that includes a pointer to a buffer in a memory system 405 and reading the vertex data from the buffer. In one embodiment, the memory system 405 may include one or more of the memory 204, the L2 cache 265, and the shared memory/L1 cache 370. The vertex data is then transmitted to the vertex shader stage 420 for processing.

The vertex shader stage 420 processes vertex data by performing a set of operations (i.e., a vertex shader or a program) once for each of the vertices. Vertices may be, e.g., specified as a 4-coordinate vector associated with one or more vertex attributes. The vertex shader stage 420 may manipulate properties such as position, color, texture coordinates, and the like. In other words, the vertex shader stage 420 performs operations on the vertex coordinates or other vertex attributes associated with a vertex. Such operations commonly including lighting operations (i.e., modifying color attributes for a vertex) and transformation operations (i.e., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shader stage 420 generates transformed vertex data that is transmitted to the hull shader stage 425.

Conventional graphics processing pipelines transmit the transformed vertex data between different stages through a set of pipeline registers or a dedicated FIFO buffer. As shown in FIG. 4, the vertex shader stage 420 may pass the vertex data directly to the hull shader stage 425.

The tessellation/primitive assembly stage 430 receives the control points passed from the hull shader stage 425 and tessellates the patches into geometric primitives for processing by the domain shader stage 435. For example, the tessellation/primitive assembly stage 430 may be configured to group every three consecutive vertices as a geometric primitive (i.e., a triangle) for transmission to the domain shader stage 435. In some embodiments, specific vertices may be reused for consecutive geometric primitives (e.g., two consecutive triangles in a triangle strip may share two vertices). After tessellation, the amount of data representing graphics geometry received as input data 401 may be significantly larger because the granularity of the geometry typically becomes finer, requiring more data, as the geometry is processed by the different stages of the graphics processing pipeline.

The domain shader stage 435 computes vertex position attributes for each tessellated vertex. The vertex position attributes generated by the domain shader stage 435 may be passed directly to the geometry shader stage 440 or may be passed to the geometry shader stage 440. The geometry shader stage 440 processes geometric primitives by performing a set of operations (i.e., a geometry shader program) on the geometric primitives. Geometry shading operations may generate one or more geometric primitives from each geometric primitive. In other words, the geometry shader stage 440 may subdivide each geometric primitive into a finer mesh of two or more geometric primitives for processing by the rest of the graphics processing pipeline 400. The geometry shader stage 440 transmits resulting geometric primitives (e.g., points, lines triangles, and the like) to the viewport stage 450.

The viewport stage 450 performs a viewport transform, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (i.e., discarded) because the geometric primitive will not contribute to the final rendered scene. Any geometric primitive that is partially inside the viewing frustum and partially outside the viewing frustum may be clipped (i.e., transformed into a new geometric primitive that is enclosed within the viewing frustum. Furthermore, geometric primitives may each be scaled based on depth of the viewing frustum. All potentially visible geometric primitives are then transmitted to the rasterization stage 460.

The rasterization stage 460 converts the 3D geometric primitives into 2D fragments. The rasterization stage 460 may be configured to utilize the vertices of the geometric primitives to setup a set of plane equations from which various attributes can be interpolated. The rasterization stage 460 may also compute a coverage mask for a plurality of pixels that indicates whether one or more sample locations for a pixel intercept the geometric primitive. In one embodiment, z-testing may also be performed to determine if the geometric primitive is occluded by other geometric primitives that have already been rasterized. The rasterization stage 460 generates fragment data (i.e., coverage masks for each covered geometric primitive) that are transmitted to the pixel shader stage 470.

The pixel shader stage 470 processes fragment data by performing a set of operations (i.e., a fragment shader or a program) on each of the fragments. The pixel shader stage 470 may generate pixel data (i.e., color values) for the fragment such as by performing lighting operations or sampling texture maps using interpolated texture coordinates for the fragment. The pixel shader stage 470 generates pixel data that is transmitted to the raster operations stage 480. In one embodiment, the pixel shader stage 470 may access data generated by an upstream processing unit. For example, the pixel shader stage 470 may read per-patch attributes that were generated by the hull shader stage 425 and/or per-primitive attributes that were generated by the geometry shader stage 440. In one embodiment, the viewport stage 450 may be configured to compute additional attributes for clipped perspective corrected barycentric coordinates that are used by the pixel shader stage 470 to perform barycentric interpolation to compute per-sample or per-pixel attributes. In another embodiment, the pixel shader stage 470 may read per-patch control point attributes and compute the per-sample or per-pixel attributes.

The raster operations stage 480 may perform various operations on the pixel data such as performing alpha tests, stencil tests, and blending the pixel data with other pixel data corresponding to other fragments associated with the pixel. When the raster operations stage 480 has finished processing the pixel data (i.e., the output data 402), the pixel data may be written to a render target such as a frame buffer, a color buffer, or the like.

It will be appreciated that one or more additional stages may be included in the graphics processing pipeline 400 in addition to or in lieu of one or more of the stages described above. Various implementations of the abstract graphics processing pipeline may implement different stages. Furthermore, one or more of the stages described above may be excluded from the graphics processing pipeline in some embodiments. Other types of graphics processing pipelines are contemplated as being within the scope of the present disclosure. Furthermore, any of the stages of the graphics processing pipeline 400 may be implemented by one or more dedicated hardware units within a graphics processor such as PPU 200. Other stages of the graphics processing pipeline 400 may be implemented by programmable hardware units such as the SM 250 of the PPU 200.

FIG. 5A illustrates a specification line 520 that defines a screen-aligned rectangle 524, in accordance with one embodiment. As shown, a specification line 520 comprises two endpoints 521(0) and 521(1) within a 3D coordinate space defined by an X axis 510, a Y axis 512 and a Z axis 514 (e.g., 3D model space). Screen-space comprises an XY plane within the 3D coordinate space. Screen-aligned rectangle 524 comprises four corners 542, 544, 546, 548, which may be generated from specification line 520. Corner 542 is located at end point 521(0). Corner 546 is projected from end point 521(1). Corner 544 is defined by the X coordinate of corner 542 and the Y coordinate of corner 546. Corner 548 is defined by the X coordinate of corner 546 and the Y coordinate of corner 542. Projected line 522 is a representation of specification line 520 in the 3D coordinate space projected into the screen-space and serves to illustrate how specification line 520 defines the geometric extent of screen-aligned rectangle 524. Specification line 520 also defines a range of rendering parameters, such as Z, which may be interpolated at each point within the screen-aligned rectangle 524. The Z axis 514 is shown herein to illustrate how a parameter plane may be derived from the specification line 520, but any other rendering parameter, such as a texture coordinate, may be similarly derived from a corresponding specification line.

FIG. 5B illustrates a constant Z plane 530 defined by one end point 521(1) of the specification line 520 of FIG. 5A, in accordance with one embodiment. The constant Z plane 530 is depicted as a circular section of a plane having a constant value of Z, which is specified at end point 521(1).

FIG. 5C illustrates a perpendicular plane 532 with respect to the specification line 520 of FIG. 5A, in accordance with one embodiment. The perpendicular plane 532 is depicted as a circular section of a plane that is perpendicular to the specification line 520, whereby the perpendicular plane also intersects end point 521(1). Here, the specification line 520 is normal to the perpendicular plane 532 (i.e., the specification line 520 intersects the perpendicular plane 532 at a 90 degree angle).

FIG. 5D illustrates an intersection line 534 defined by the constant Z plane 530 of FIG. 5B and the perpendicular plane 532 of FIG. 5C, in accordance with one embodiment. Intersection line 534 represents the geometric intersection of the constant Z plane 530 and the perpendicular plane 532.

FIG. 5E illustrates a spanning plane 540 is defined by a plane equation that is associated with the specification line 520 of FIG. 5A and the intersection line 534 of FIG. 5E, in accordance with one embodiment. A plane equation for spanning plane 540 may be derived using any technically feasible technique. For example, the plane equation for spanning plane 540 may be derived by solving for a plane that intersects any point along specification line 520 in combination with any two points along intersection line 534. Similarly, the plane equation for spanning plane 540 may be derived by solving for a plane that intersects any two points along specification line 520 in combination with any one point along intersection line 534. In one embodiment, the plane equation is derived in the form of Z=aX+bY+c, where constants a, b, and c are coefficients computed by solving a linear system of three equations and three unknowns for a particular rendering parameter.

In one embodiment, the plane equation is used to compute Z at any point (X,Y) within the screen-aligned rectangle 524. In other embodiments, the plane equation is used to compute another rendering parameter associated with screen-aligned rectangle 524. A given rendering parameter may be directly computed from a corresponding plane equation.

FIG. 6 illustrates a flow chart of a method for rasterizing the screen-aligned rectangle 524 based on parameters specified by a plane equation associated with the specification line 520, in accordance with one embodiment. Although method 600 is described in conjunction with FIGS. 2-4, persons of ordinary skill in the art will understand that any system that performs method 600 is within the scope and spirit of embodiments of the present invention.

Method 600 begins in step 610, where rasterization stage 460 of graphics processing pipeline 400 receives coordinates and a plane equation for the screen-aligned rectangle 524. The plane equation may be represented by the coefficients for a particular rendering parameter. The coordinates may define a graphics primitive corresponding to the screen-aligned rectangle 524. In one embodiment graphics processing pipeline 400 is implemented within a GPU. In step 612, the rasterization stage 460 generates coverage for the screen-aligned rectangle 524 based on the coordinates corresponding to the screen-aligned rectangle 524. The coverage that is generated may be per-pixel coverage information for the screen-aligned rectangle 524 in screen-space. For example, the coverage may indicate that the screen-aligned rectangle 524 covers an entire display (e.g., a background image) or may cover a portion of a display (e.g., a window, icon, menu, or the like).

In step 614, a processing element within the graphics processing pipeline 400 computes a rendering parameter value, such as Z for the screen-aligned rectangle 524. The rendering parameter value is computed based on the coordinates of the pixels that are covered by the screen-aligned rectangle 524 using the plane equation for the spanning plane 540. In one embodiment, pixel shader stage 470 computes the parameter value. If, in step 620 the last pixel covered by the screen-aligned rectangle 524 has been processed, then the method terminates; otherwise, the method proceeds back to step 614.

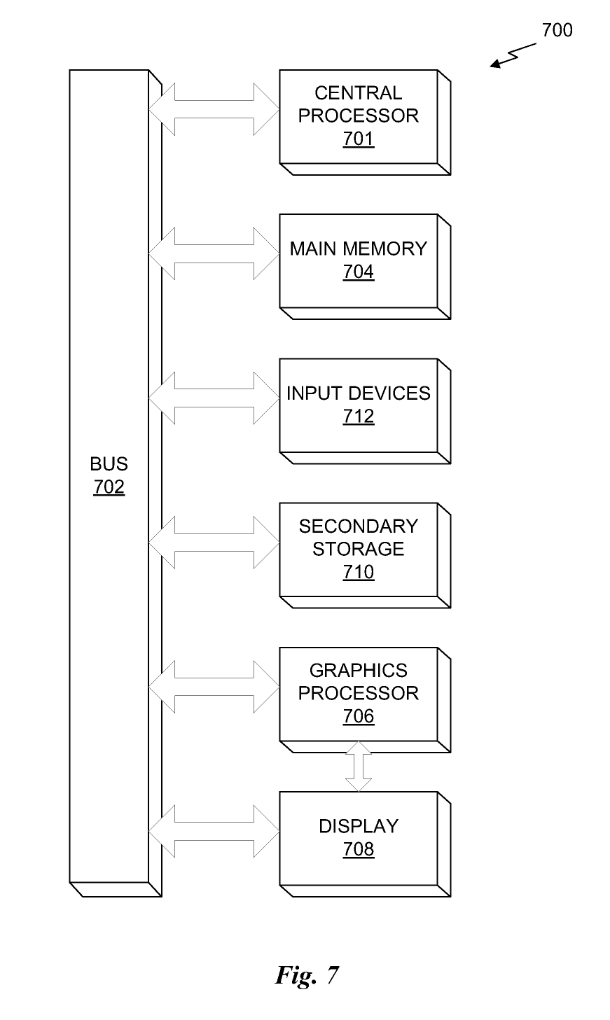

FIG. 7 illustrates an exemplary system 700 in which the various architecture and/or functionality of the various previous embodiments may be implemented. As shown, a system 700 is provided including at least one central processor 701 that is connected to a communication bus 702. The communication bus 702 may be implemented using any suitable protocol, such as PCI (Peripheral Component Interconnect), PCI-Express, AGP (Accelerated Graphics Port), HyperTransport, or any other bus or point-to-point communication protocol(s). The system 700 also includes a main memory 704. Control logic (software) and data are stored in the main memory 704, which may take the form of random access memory (RAM).

The system 700 also includes input devices 712, a graphics processor 706, and a display 708, i.e. a conventional CRT (cathode ray tube), LCD (liquid crystal display), LED (light emitting diode), plasma display or the like. User input may be received from the input devices 712, e.g., keyboard, mouse, touchpad, microphone, and the like. In one embodiment, the graphics processor 706 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 700 may also include a secondary storage 710. The secondary storage 710 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. Computer programs, or computer control logic algorithms, may be stored in the main memory 704 and/or the secondary storage 710. Such computer programs, when executed, enable the system 700 to perform various functions. The main memory 704, the storage 710, and/or any other storage are possible examples of computer-readable media.

In one embodiment, the architecture and/or functionality of the various previous figures may be implemented in the context of the central processor 701, the graphics processor 706, an integrated circuit (not shown) that is capable of at least a portion of the capabilities of both the central processor 701 and the graphics processor 706, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 700 may take the form of a desktop computer, laptop computer, server, workstation, game consoles, embedded system, and/or any other type of logic. Still yet, the system 700 may take the form of various other devices including, but not limited to a personal digital assistant (PDA) device, a mobile phone device, a television, etc.

Further, while not shown, the system 700 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
determining coordinates for a screen-aligned rectangle by projecting a specification line onto a screen-space plane, wherein the specification line is within a three-dimensional (3D) space;
computing a plane equation associated with the specification line; and
rasterizing the screen-aligned rectangle that is within the screen-space plane based on the coordinates and the plane equation, wherein the plane equation corresponds to a rendering parameter for the screen-aligned rectangle.

2. The method of claim 1, wherein the rendering parameter comprises a depth value.

3. The method of claim 1, wherein the rendering parameter comprises a texture coordinate value.

4. The method of claim 1, wherein the plane equation comprises a sum of three terms, the first term being a first constant multiplied by a first screen-space coordinate, the second term being a second constant multiplied by a second screen-space coordinate, and the third term being a third constant.

5. The method of claim 1, wherein computing the plane equation comprises:
determining a constant parameter plane based on a selected end point of the specification line;
computing a perpendicular plane that is perpendicular to the specification line at the selected end point;
computing an intersection line based on the constant parameter plane and the perpendicular plane; and
generating the plane equation for a spanning plane based on the intersection line and the specification line.

6. The method of claim 1, wherein computing the plane equation comprises solving a linear system of three equations and three unknowns.

7. The method of claim 1, wherein rasterizing the screen-aligned rectangle comprises:
generating coverage for the screen-aligned rectangle based on the coordinates; and
computing a rendering parameter value based on the coverage and the plane equation.

8. The method of claim 7, further comprising determining that a last pixel covered by the screen-aligned rectangle has been processed.

9. The method of claim 7, wherein generating the coverage is performed by a rasterization unit within a graphics processing unit.

10. The method of claim 7, wherein computing the rendering parameter is performed by a pixel shader within a graphics processing unit.

11. A computer-readable storage medium storing instructions that, when executed by a processor, causes the processor to perform steps comprising:
determining coordinates for a screen-aligned rectangle by projecting a specification line onto a screen-space plane, wherein the specification line is within a three-dimensional (3D) space;
computing a plane equation associated with the specification line; and
rasterizing the screen-aligned rectangle that is within the screen-space plane based on the coordinates and the plane equation,
wherein the plane equation corresponds to a rendering parameter for the screen-aligned rectangle.

12. The computer-readable medium of claim 11, wherein the rendering parameter comprises a depth value, and wherein the plane equation comprises a sum of three terms, the first term being a first constant multiplied by a first screen-space coordinate, the second term being a second constant multiplied by a second screen-space coordinate, and the third term being a third constant.

13. The computer-readable medium of claim 11, wherein computing the plane equation comprises:
determining a constant parameter plane based on a selected end point of the specification line;
computing a perpendicular plane that is perpendicular to the specification line at the selected end point;
computing an intersection line based on the constant parameter plane and the perpendicular plane; and
generating the plane equation for a spanning plane based on the intersection line and the specification line.

14. The computer-readable medium of claim 11, wherein rasterizing the screen-aligned rectangle comprises:
generating coverage for the screen-aligned rectangle based on the coordinates; and
computing a rendering parameter value based on the coverage and the plane equation.

15. The computer-readable medium of claim 11, wherein generating the coverage is performed by a rasterization unit within a graphics processing unit.

16. The computer-readable medium of claim 11, wherein computing the rendering parameter is performed by a pixel shader within a graphics processing unit.

17. A system comprising:
a memory system; and
a processing pipeline, configured to:
determine coordinates for a screen-aligned rectangle by projecting a specification line onto a screen-space plane, wherein the specification line is within a three-dimensional (3D) space;
compute a plane equation associated with the specification line; and
rasterize the screen-aligned rectangle that is within the screen-space plane based on the coordinates and the plane equation,
wherein the plane equation corresponds to a rendering parameter for the screen-aligned rectangle.

18. The system of claim 17, wherein the processing pipeline is further configured to:
determine a constant parameter plane based on a selected end point of the specification line;
compute a perpendicular plane that is perpendicular to the specification line at the selected end point;
compute an intersection line based on the constant parameter plane and the perpendicular plane; and
generate the plane equation for a spanning plane based on the intersection line and the specification line.

19. The system of claim 17, wherein rasterizing the screen-aligned rectangle comprises:
generating coverage for the screen-aligned rectangle based on the coordinates; and
computing a rendering parameter value based on the coverage and the plane equation.

20. The system of claim 19, wherein computing the rendering parameter is performed by a pixel shader within a graphics processing unit.
